(19) United States
(12) Patent Application Publication
(10) Pub. No.: US 2019/0370822 A1
(43) Pub. Date: Dec. 5, 2019

(54) Computer-Implemented System And Method For Cloud-Based Industrial Equipment Acquisition

(71) Applicant: ShareGrid, Inc., Seattle, WA (US)

(72) Inventors: Marius Ciocirlan, Seattle, WA (US); Arash Shiva, Seattle, WA (US); Siavash Shiva, Seattle, WA (US); James Newton, Seattle, WA (US)

(21) Appl. No.: 16/432,850

(22) Filed: Jun. 5, 2019

Related U.S. Application Data
(60) Provisional application No. 62/681,017, filed on Jun. 5, 2018.

(51) Int. Cl. G06Q 30/00; H04L 29/08; G06F 16/9535; G06F 16/9538; G06Q 10/08

(52) U.S. Cl. CPC G06Q 30/0185; H04L 67/10; G06Q 10/087; G06F 16/9538; G06F 16/9535

(57) ABSTRACT

A computer-implemented system and method for cloud-based industrial equipment acquisition are provided. A query having a list of industrial equipment is received. Fraud analysis is performed on the query to determine whether the query is valid. When valid, at least two results are received for the query from vendors of the industrial equipment. Each result includes one or more pieces of industrial equipment. The results are reviewed by comparing the industrial equipment listed in each the results with the list of industrial equipment provided in the query and identifying any pieces of the industrial equipment that are missing from each of the results. At least one of the vendors is notified that at least one piece of industrial equipment is missing from the result associated with that vendor. A revision of the result associated with the vendor is received and delivered to the user in response to the query.

### CROSS-REFERENCE TO RELATED APPLICATION

This non-provisional patent application claims priority under 35 U.S.C. § 119(e) to U.S. Provisional Patent application, Ser. No. 62/681,017, filed Jun. 5, 2018, the disclosure of which is incorporated by reference.

### FIELD

The invention relates in general to processing and fulfilling search queries and, in particular, to a computer-implemented system and method for cloud-based industrial equipment acquisition.

### BACKGROUND

Video productions and photo shoots require lots of planning and equipment to execute. Most production companies rent the equipment, such as cameras, lenses, lighting, audio, drones, and other accessories from rental houses, which are mostly brick and mortar stores. The equipment is sophisticated and expensive, and is generally only available at the specialized rental houses. Availability of the equipment depends on the date and time needed. For example, orders placed on Wednesday or Thursday, are usually picked up on Fridays and returned on Mondays, with the production occurring over the weekend.

During a video or photo production, a director or other individual must compile a list of equipment needed for the production, and locate and rent the equipment. A production company usually has a rental contract in place with a single rental house since filling out the paper work and obtaining insurance can be difficult and time consuming. However, often times, the rental house that has a relationship with the user does not have all the necessary equipment available when needed and the equipment must be subrented from another rental house, through the related rental house, at an extremely high cost. If the production company wants to rent from a different rental house, a contract must be signed and insurance must be obtained for that rental house. Further, due to maintaining a relationship with a single rental house, the production company is tied to the costs of that rental company and is discouraged from shopping around for lower or the lowest rental rates.

Accordingly, there is a need for a convenient and efficient fulfillment of equipment over a short time period. Preferably, the equipment can be obtained from multiple vendors when necessary.

### SUMMARY

An embodiment provides a computer-implemented system and method for cloud-based industrial equipment acquisition. A query having a list of industrial equipment is received. Fraud analysis is performed on the query to determine whether the query is valid. When valid, at least two results are received for the query from vendors of the industrial equipment. Each result includes one or more pieces of industrial equipment. The results are reviewed by comparing the industrial equipment listed in each the results with the list of industrial equipment provided in the query and identifying any pieces of the industrial equipment that are missing from each of the results. At least one of the vendors is notified that at least one piece of industrial equipment is missing from the result associated with that vendor. A revision of the result associated with the vendor is received and delivered to the user in response to the query.

Still other embodiments of the invention will become readily apparent to those skilled in the art from the following detailed description, wherein are embodiments of the invention by way of illustrating the best mode contemplated for carrying out the invention. As will be realized, the invention is capable of other and different embodiments and its several details are capable of modifications in various obvious respects, all without departing from the spirit and the scope of the invention. Accordingly, the drawings and detailed description are to be regarded as illustrative in nature and not as restrictive.

### BRIEF DESCRIPTION OF THE DRAWINGS

FIG. 1 is a block diagram showing a system for cloud based equipment acquisition, in accordance with one embodiment.

FIG. 2 is a flow diagram showing, by way of example, a method for performing query fulfillment via the equipment acquisition system of FIG. 1.

FIG. 3 is a flow diagram showing a method for cloud based equipment acquisition, in accordance with one embodiment.

FIG. 4 is a block diagram showing, by way of example, a screenshot of an interface for entering a query.

FIG. 5 is a block diagram showing, by way of example, a screenshot of an interface for a notification of the query of FIG. 4.

FIG. 6 is a block diagram showing, by way of example, a screenshot of an interface for providing details about the query of FIG. 4.

FIG. 7 is a block diagram showing, by way of example, a screenshot of an interface for providing a summary of results for the query of FIG. 4.

FIG. 8 is a block diagram showing, by way of example, a screenshot of an interface for presenting results for the query of FIG. 4.

FIG. 9 is a block diagram showing, by way of example, a screenshot of an interface for a selected result for the query of FIG. 4.

### DETAILED DESCRIPTION

Due to the cost of owning and storing specialized video and photo production equipment, most production companies rent the equipment from a rental house with whom the production company has a prior relationship. The relationship can be formalized by the signing of a general rental contract and proof of insurance. Reviewing and negotiating the contract and obtaining insurance is time consuming, which results in production companies forming relationships with a minimal number of rental houses. When the rental houses of the production company do not have available or carry the equipment desired, the production company must subrent the equipment from another company at extremely high rates to prevent signing of another contract by the user and obtaining insurance with the other rental house.

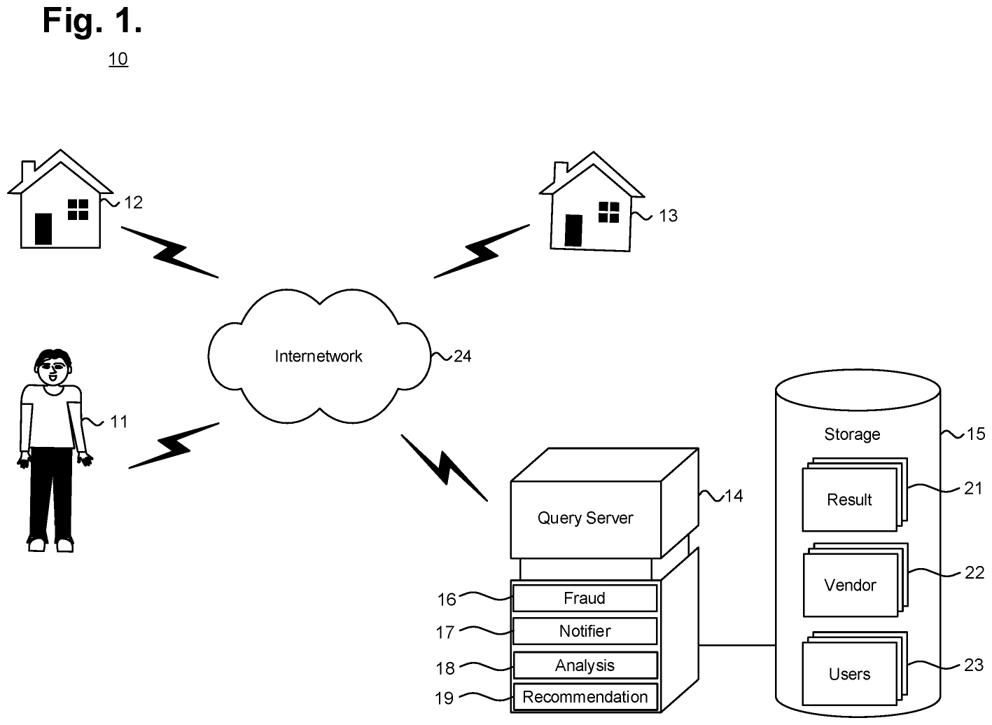

A cloud based industrial equipment acquisition system allows an individual or production company to easily and quickly identify and obtain available equipment across different sources. FIG. 1 is a block diagram showing a system 10 for a cloud based industrial equipment acquisition system, in accordance with one embodiment. A user or renter 11 working on a project that requires production equipment, such as lights, cameras, tripods, and microphones, submits a query for rental equipment via a computing device, such as a mobile phone, laptop, or tablet. The query is provided over an internetwork 24, such as the Internet, to a query server 14, which includes a fraud detection module 16, such as a fraudbot, a project notification module 17, a result analysis module 18, and a recommendation module 19. Alternatively, the system 10 can operate via a cloud computing environment, which allows end users to access and utilize remotely-stored applications (not shown) without requiring the users to install software or personal data. Instead, clients receive cloud-based software 16-19 and stored data 21-23.

Prior to, during, or after receipt of the query, information about the user is obtained and stored in a database 15 interconnected to the query server 14. Information about the user can include user name, associated production company, location, responsibility rating, and insurance verification. Other types of information are possible. In one embodiment, the information about the user can be obtained via a document that is filled out by the user. Additionally, the database 15 can store a copy of the user's insurance verification, which can be provided to the vendor if the user damages the vendor's equipment.

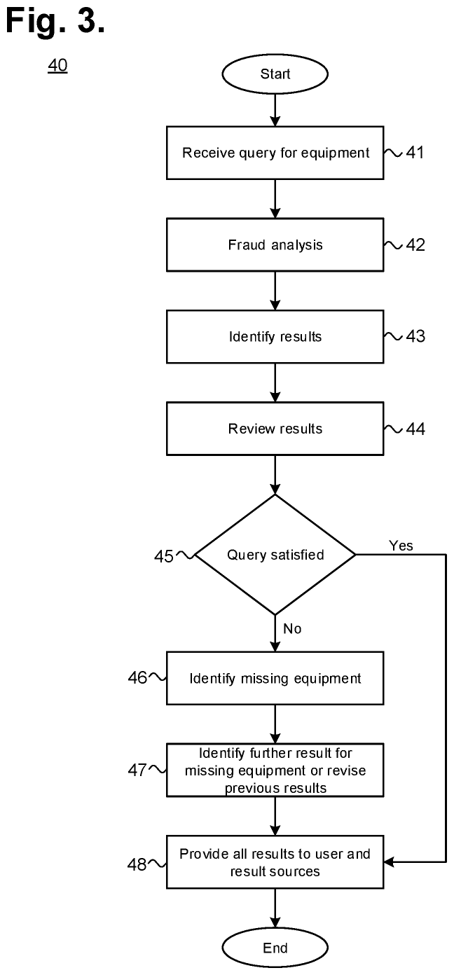

Upon receipt, the fraud detection module 16 analyzes the query to determine whether the query is valid prior to processing the query, as described in detail below with respect to FIG. 3. If determined to be invalid, the query can be further reviewed, terminated, or sent back to the user 11. However, if valid, the project notification module 17 sends notice of the query to vendors 12, 13 for generating results to the query. The vendors 12, 13 represent sources of equipment, such as rental houses and individuals that own the equipment. A list 22 of the vendors can be stored in the database 15 with information, such as contact information, satisfaction rating, and location of business. However, other types of information are possible. One or more of the vendors can be identified from the list and the query is provided to the identified vendors. Alternatively, notification of the query can be provided to all the vendors in the list.

Subsequently, the vendors 12, 13 can generate and provide to the query server 14 a query result 21, which can be provided immediately to the user as a result or can be stored in the database 15 until a predetermined time has been reached for sending the result. From here on the terms query result and bid result can be used interchangeably. The response results can be generated by a single vendor or on behalf of two or more vendors, as further described below with respect to FIG. 3. The predetermined time can be utilized to ensure that all results are collected and provided to the user at one time. However, regardless of when the results are provided to the user, the analysis module 18 can review each result to identify whether any equipment from the query is missing. If missing, the vendor associated with the result can be notified for revising the result or pairing with another vendor that has the missing equipment available. Also, prior to providing the results to the user, the recommendation module 19 can provide a recommendation of one or more of the results received from the vendors, a rental cost, and whether a discount should be offered. Other types of recommendations are possible. The recommendations can be tailored to making the vendor's bid result more favorable for selection by the user.

Finally, the results are provided to the user. Once presented, the user can select one or more of the results for further review and discussion with the vendor regarding renting equipment.

The computing devices and servers can each include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, as integrated circuitry and each of the client and server can act as a specialized computer. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

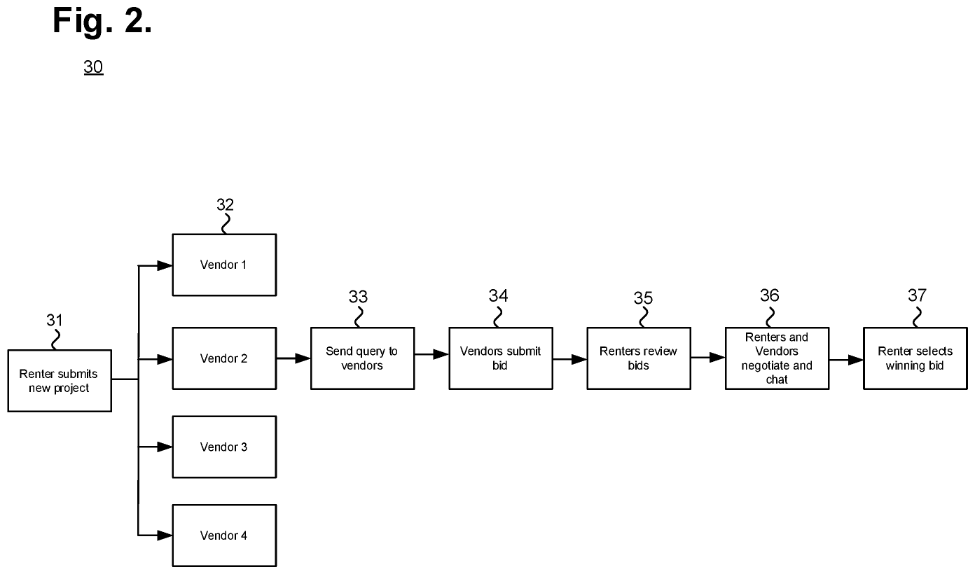

Users, such as producers or directors of a video or photo production can submit a query to one or more vendors for locating available equipment needed for the production. FIG. 2 is a flow diagram showing a process 30 for performing query fulfillment via the equipment acquisition system of FIG. 1. A user looking to rent equipment generates and submits (step 31) a query for a production project. The query can include a rental request for one or more pieces of equipment for the production project and a time period during which the equipment is needed. A list of vendors (step 32) for sending the query can be generated and based on the list, the query can be provided (step 33) to those vendors on the list. Each vendor can be a source of equipment, such as rental houses. In one embodiment, the query is provided to all vendors registered with the equipment acquisition system. However, in a further embodiment, the query can be made available to only a select set of the vendors or can be provided to remaining vendors after first being provided to the select set of vendors.

Upon receipt of the query, each vendor can generate and submit (step 34) a bid. The bids can include an indication as to whether each piece of equipment listed in the query is available during the listed time period and a cost of each piece of available equipment. The bids are then provided as query results to the user at a single time or as the query results are received. The user can review (step 35) the query results, and negotiate and obtain (step 36) additional information from one or more of the vendors. After review of the query results, the user can select (step 37) one or more of the results for acquisition of the rental equipment.

Prior to providing the query results to the user, the results from the vendors can be processed to identify any missing equipment in the results. If identified, one or more vendors can be contacted to identify the missing equipment so that each piece of equipment listed in the query appears in one or more results. FIG. 3 is a flow diagram showing a method 40 for cloud based equipment acquisition, in accordance with one embodiment. The equipment acquisition system receives (step 41) a query for equipment from a user and optionally performs (step 42) fraud analysis to determine whether a production project for which the query is generated is real, and not fraudulent or potentially fraudulent. In one embodiment, the user's identity is hidden and the fraud analysis can assure the vendors that the production project is valid. Machine learning, a classifier, or rule based systems can be used to identify fraudulent projects.

For instance, a determination of whether the project is real can be based on a set of rules. In one example, a predetermined number of points can be assigned to elements of the query, such as days and times the request was made, an identity of the user, requests for non-compatible equipment, and a cost of the equipment, as well as other types of elements. For example, if a user generates a query for a project on a Saturday night at 2 a.m., a predetermined number of points can be assigned based on the time of day that the query was submitted. For instance, a higher number of points can be assigned to queries generated during a time of night when most people are asleep. Additionally, if a user generates a project that includes a camera and a lens that doesn't fit the camera, a predetermined number of points is assigned based on the incompatability of the equipment. Other rules are possible.

The fraud analysis can also consider the user that submitted the query. For instance, points can be assigned to a user based on a set of rules, including a length of time the user has used the equipment acquisition system, a percentage of late returns, and returned equipment condition, to identify the user as trustworthy, which may trigger a preferred price by one or more vendors. Additionally, the user's social media accounts can be accessed and reviewed to determine whether that user is trustworthy using factors such as a number of production projects managed or participated in by the user and a length of time in the video and photo industry.

After all or a portion of the rules are applied to the project query and the user that submitted the query, the assigned points are totaled and a threshold is applied to the totaled points score. If the totaled points score exceeds the threshold, a fraud notification is generated for the project and can be flagged for further review, dismissal, or return to the user. In one example, a machine can be trained to identify and classify queries as fraudulent projects. If the total points score falls below the threshold, one or more results are collected (step 43) from the vendors and reviewed (step 44) to determine whether each piece of equipment in the query is identified (step 45) in at least one of the bid results. If each piece of equipment is identified (step 45), the results can be provided to the user (step 48). Otherwise, if one or more pieces of equipment are missing from each of the received results, the missing equipment is identified (step 46).

The missing equipment can be identified via an inventory list of the equipment, which is generated based on the query. As bids are received from the vendors, the bid can be compared to the inventory list to determine whether each bid includes all of the equipment listed in the query or only a portion. In a further embodiment, an API can be utilized to keep the vendor's inventory synched with the equipment acquisition system so that the system can run a review to determine whether the vendor has particular equipment available during a particular time.

If equipment is missing, a notification can be generated and sent to the vendor with possible suggestions for subrenting the missing equipment or working with another vendor to submit a joint query as a result. For example, a vendor is notified that he has only 80% of the equipment needed for the project. The notification to the vendor provides a list of other vendors with the remaining 20% of the equipment available. To identify vendors with the missing equipment, the system can check the inventories of those vendors.

If desired, the vendor that received the project notification can contact (step 47) the other vendors to submit a joint result or the vendor can rent (step 47) the equipment from one of the other vendors and then revise the bid as a result for the query. For example, a single response result can be generated on behalf of two or more vendors to ensure a complete list of equipment, which may be more desirable to the user. In a joint bid result, the vendors each supply a portion of the equipment, which are packaged as a single offer for rent. Alternatively, the user can select multiple vendors, such as from two separate result bids that are each incomplete, for renting from. Finally, the results are then provided (step 48) to the user. As described above with respect to FIG. 2, the query results can be provided to the user as received and reviewed, or at the end of the predetermined time during which the query results are received and stored, until the predetermined time expires.

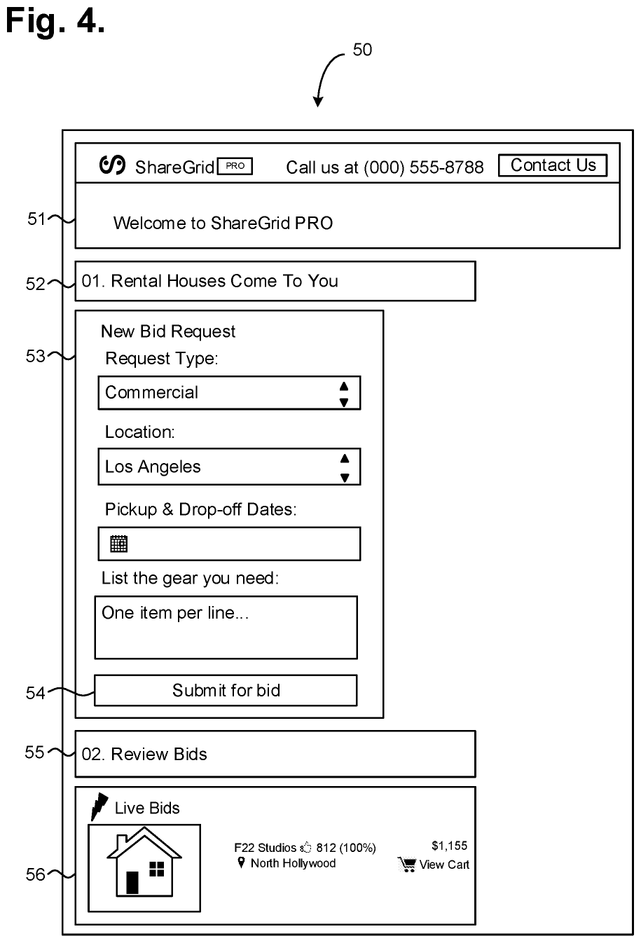

To generate the query for submission, the user can fill out an interactive form. FIG. 4 is a block diagram showing, by way of example, a screenshot of an interface 50 for entering a query. The interface 50 can be provided via a web page or a mobile application, and can include an interactive form 53 for generating the query for equipment. Users that wish to rent equipment can access the interactive form 53 for submitting a query. For example, the user can navigate to and log into sharegrid.com. The website associated with the web address can create a new ShareGrid PRO project and assign that project to the user's account.

The interface 50 can capture a variety of information regarding the project and the renting individual, including type of project, location of the project, pick up and drop off dates for the equipment, and the equipment needed. Other types of information are possible. Specifically, the interface 50 can include an introduction 51, and an index of headings 52, 55 outlining the query fulfillment process, such as described above with respect to FIG. 2. A first heading in the index 52 can provide data fields 53 for obtaining information to generate a query for a bid request. The data fields 53 can include request type, location, pickup and dropoff dates, a list of equipment, and other fields, such as range of cost and options for pick up or delivery of the equipment. Once the requested information has been provided, the user can select the submit bid button 54 for generating a query. The information captured via the website is stored in a database and once the project bid is submitted as a query, email and SMS notifications can be sent to all parties involved, including the renter, one or more vendors and ShareGrid staff. Other headings in the index can include bid or result review 55, which provides a list 56 of live results provided by vendors. Other headings and content are possible.

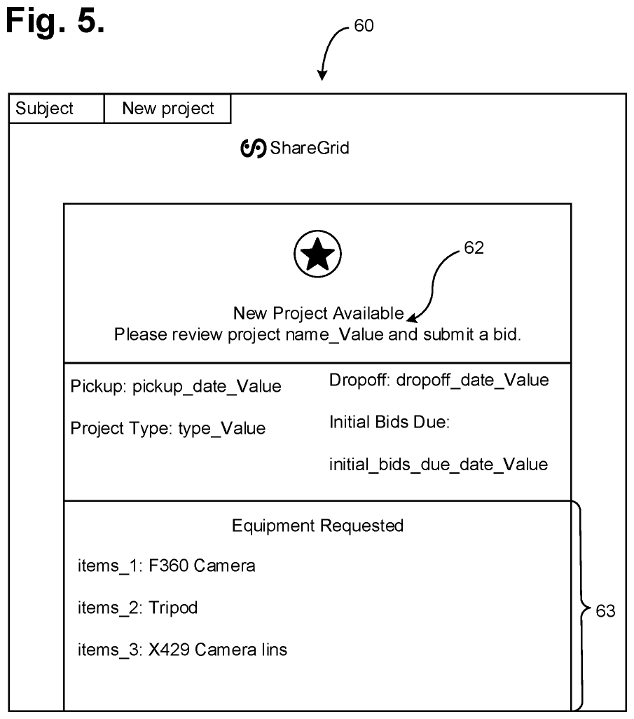

After the query has been submitted, the equipment acquisition system can provide the query to one or more vendors. FIG. 5 is a block diagram showing, by way of example, a screenshot of a notification 60 of the query of FIG. 4. The project query can be distributed to various vendors registered with and stored in the system's database. In one embodiment, the query can be provided to all the vendors listed in the database or to a select group of vendors. The group of vendors can be selected based on one or more factors associated with the query, such as the vendor is located within a predetermined distance of the user or the vendor usually rents equipment for a price that falls within the user's budget or the vendor has a high reputation score. Other types of factors are possible, such as account past rental performance, past response rate, past customer reviews, location, inventory list and availability, facility attributes, delivery capabilities, technician service quality and past result patterns. Based on the factors, the system selects those vendors that are determined to be the most suitable for providing the query.

The notification 60 of the query received by the identified vendors can include a name of the project generated by the system for the query 61 and information 63 from the query, such as pick up date, drop off date, project type, and list of equipment. Additionally, the notification 60 can include a deadline for submitting bid results for the project query.

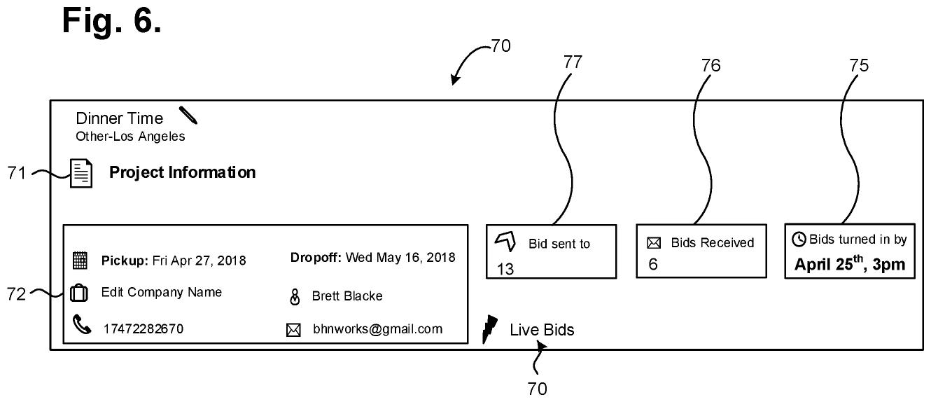

Detailed data for the project query can be collected and provided to the user. FIG. 6 is a block diagram showing, by way of example, a screenshot showing an interface 70 for details about the query of FIG. 4 and results of the query. After the query for the project becomes live and notifications are sent out to inform vendors of the new project, vendors can start submitting bid results. The results can be provided to the user upon receipt from the vendors or can be released at an initial result due date, which can be determined automatically or manually. The initial result due date can be determined based on a number of active projects, available inventory, seasonality within the industry, time of day and week, and size of the order. The result date should optimize a time that will be best fit to provide competitive pressure on rental vendors, but also give them enough time to participate. For example, a search can be run to determine a number of vendors that can fulfill the query order during a specific date and time based on an inventory list for each vendor that is maintained by the system. If the number of available vendors is low, the initial result due date can be longer to allow other vendors to acquire the necessary equipment to fulfill the query. After the initial result due date has passed, only vendors that submitted a result before the initial result due date will be able to continue to adjust their bid result until the renter selects one of the results, the project is terminated by the user, or the project is ended via an automated timer.

The summary interface 70 can include information about the project query 71, such as a copy of the query, information 72 about the user, such as name and contact information, a number of vendors that received the query 73, a number of bid results received from the vendors 74, and a deadline for submitting bid results 75. The interface 70 can also include a link 76 to view the bid results already received from the vendors.

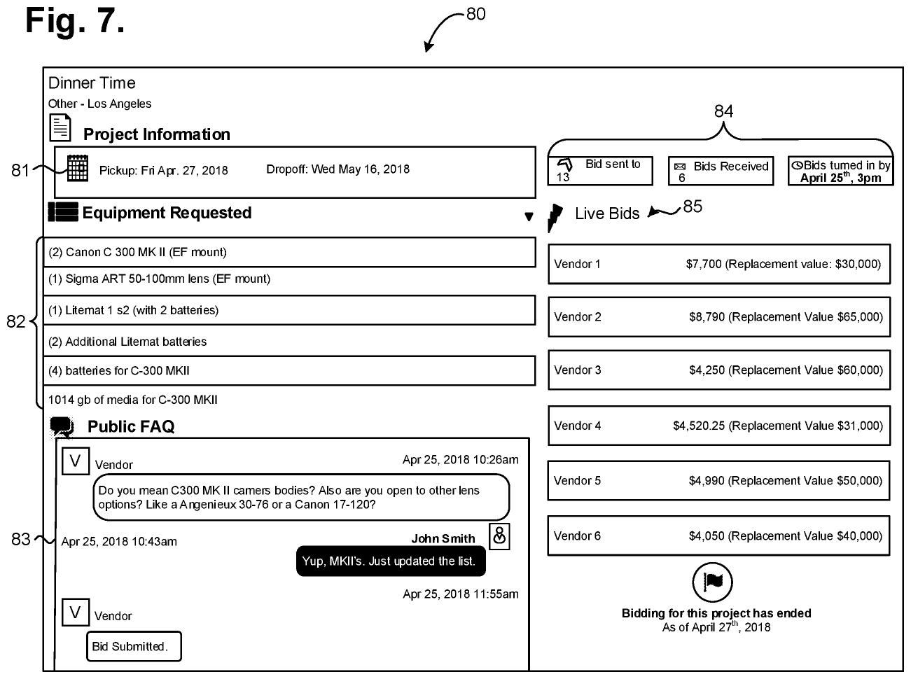

A summary of the query and bid results received from the vendors can be provided to vendors to allow the vendors to compare their bid to competitors' bids. FIG. 7 is a block diagram showing, by way of example, a screenshot of a dashboard interface 80 for a summary of results for the query of FIG. 4. Vendors can navigate different projects using a directory of projects (not shown) or by clicking on a link from one of the query notifications provided via SMS or email. Once at the project dashboard, the vendors are able to review information regarding the specific project and a list of equipment for the project.

The interface 80 can include information about the project 81, a list of equipment requested 82, questions asked about the project by one or more vendors 83, information 84 about a number of vendors that received the bid, a number of bids received from the vendors, and the bid deadline, as well as a list of the received bids 85. Each of the received bids can include an identity of the vendor or a generic name of each vendor to prevent the vendor's identity. Additionally, a price for rental of the equipment can be included in the list of received bids, along with a replacement value should the equipment become lost or broken.

Based on the summary information, the equipment acquisition system can identify if there are certain items on the equipment list that the viewing vendor does not have in its profile inventory list maintained by the system and can suggest alternative sub-rental options along with price estimates so that the user can submit a complete bid result, as described in detail above with respect to FIG. 4.

If a vendor is reviewing the interface prior to placing a bid result, the vendor can fill out the necessary input information such as rental price, replacement value for the equipment should the equipment be damaged or lost, and a “sizzle note,” which acts as a marketing tool to help the vendor stand out among other results from other vendors, after reviewing the needs of the project as well as assessing their own capability of fulfilling the project. Other input information is possible. The sizzle note can include information about the vendors, such as awards won, clients serviced, or any other information that would persuade the user to accept the bid result of that vendor. Alternatively, is the vendor has already submitted a bid result, the vendor can revise the bid result after considering the bid results of other vendors.

A suggestion or recommendation system can guide the vendor into placing the best result based on their ability and various other factors by providing recommendations for generating a bid result. This suggestion system can take into account external factors, historic data, and individual vendor and renter attributes. Specifically, the data will lead the system to provide the most competitive result price range. External factors can be based on industry data that focuses on a volume of projects available during certain days, week, month or quarter, as well as financial performance of certain camera manufactures, production companies, and rental facilities. Historic data can play a huge role in the system's ability to predict and suggest the correct result price, and can include all rental pricing information, similar inventory lists and rental pricing data from previous project queries and results.

Individual vendor and renter attributes can contribute to the result price recommended by the suggestion system. For example, the attributes for a renting user can be determined based on the user's production history, portfolio, budget, social following, and fraud detection scoring, as well as past rental reviews. The system can suggest a price to a vendor that the renter would potentially find appealing based on the renting user's attributes. The system will also analyze the vendor attributes, such as the vendors' rental history, inventory pricing history, inventory availability, other active projects, team size, and company attributes, such as number of technicians or delivery capability, for use in suggesting a response result to the query to assist the vendor with the best chance for result selection.

Once the account external factors, historic data, and individual vendor and renter attributes are considered, the suggestion system provides the recommended result to the vendor for responding to the query. The recommendation can be determined by calculating a score for the external factors, historical data, and individual attributes and then comparing the score to a set of guidelines to determine whether a lower price or a promotional deal should be offered. For example, points can be awarded for the account external factors, historic data, and individual vendor and renter attributes. If the points exceed a predetermined threshold, a recommendation for a lower price or promotional deal can be made. However, other methods for determining the recommendation are possible. The vendor can submit the recommended result as is, can revise or edit the recommended result, or submit a different result.

The summary data displayed in the interface 80, which can be accessed and viewed by vendors that received a notification of the project query, can be anonymized so that vendors can only see certain types of information for use in generating or revising their own bid results. For example, vendors may not be able to see competing vendors' names, reviews for those vendors, or vendor location in the summary data 85 or in the chat area 83. Additionally vendors may not be able to see specific information about an identity of the renter, such as the renter's production company name, username, or associated staff.

However, to alleviate any concerns on behalf of the vendors and users regarding a trustworthiness of the other party, vendors and users can be assigned a trustworthiness score. The trustworthiness score of the vendors and users can be provided to the users and vendors, respectively, and can be determined over time. For instance, the score can be calculated via a rule based system that assigns points when a rule is satisfied, as described above with respect to FIG. 4. The longer a user has participated, the more points a user receives. Also, the more trustworthy a user, the better results the user may receive from the vendors. In one embodiment, a new user can start with a predetermined amount of points and negative points can be awarded for trustworthy actions, such as a positive rental experience or length of time participating within the system, while positive points are added for events that are considered untrustworthy, such as late return of equipment or payment declined. Thus, a lower score indicates a more trustworthy user. The trustworthiness score provides the vendors with information about the user without disclosing the user's identity.

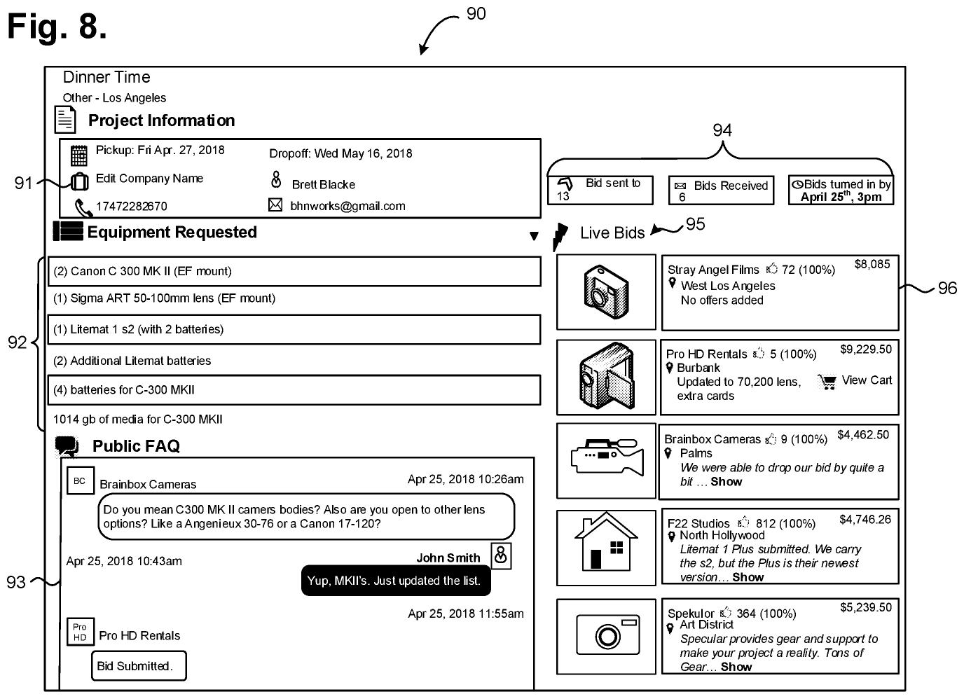

A summary of the bid results provided to the user can also be displayed for direct comparison of the bids by that user. FIG. 8 is a block diagram showing, by way of example, a screenshot of an interface 90 for presentation of results for the query of FIG. 4. The interface 90 can appear similar to the bid summary interface provided to the vendors, described above with reference to FIG. 7, but can include additional information. For example, the interface 90 can include information about the project query 91, a list of equipment requested 92, questions asked about the project by one or more vendors 93, information 94 about a number of vendors that received the bid, a number of bids received from the vendors, and the bid deadline, and a list of the received bids 95. The list of received bids 95 includes individual bids 96 provided to the user as a result of the query, which can be displayed with a name of the vendor, a satisfaction rating or score, a location of the vendor, any discounts or specials offered to the user, and a rental price for the specific pieces of equipment listed by that vendor. Renter users can communicate directly with one or more of the vendors via the public chat room or other types of communication to discuss the bid result in additional detail before selecting one or more vendors to rent from.

A series of notifications can be pushed via SMS, email and native mobile notification systems to get both parties to act on providing a result to the query, adjusting or selecting a winning result. Vendors can be notified when a project is submitted, when it's due, if the project is changed, if the client starts a conversation in the chat area and a series of notifications will alert the vendor if other vendors have more competitive results than them. The notifications will also provide suggestions on how to adjust the results and increase chances to win the project. For example, the notification can indicate that another vendor has provided a result with a lower price so that the vendor can reduce his original result, if desired.

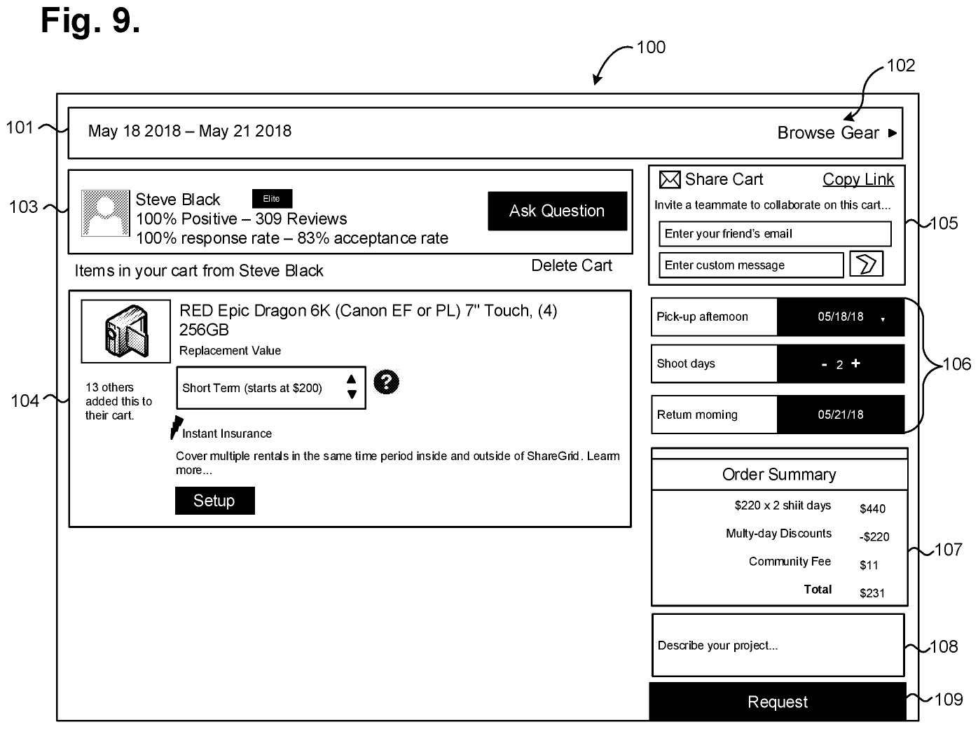

After reviewing the query results and communicating with the vendors, the user can select the bid or query result from one or more vendors. FIG. 9 is a block diagram showing, by way of example, a screenshot of an interface 100 for a selected result for the query of FIG. 4. Upon receipt and review of the query results, user renters can select one or more of the query results by placing the result into a digital shopping cart for acceptance and rental. Alternatively, the user can select a request button associated with the desired bid result for direct delivery to the vendor.

The interface 100 for a result selected by the user can include a time period during which the rental equipment is desired, a link or dropdown menu 102 for accessing a list of other rental equipment being offered by the vendor, information about the vendor 103, including identity and reviews, a list of items 104 to be rented from the vendor, a link and address box 105 to enter a third party's email address for sharing the equipment items to be rented, pickup and dropoff information 106 for the rental equipment, a summary of cost for the rental equipment 107, and a text box for providing further information about the production project 108. After review, the user can select the request button 109 for submitting a request for the bid result.

Once the vendor receives and accepts the rental request of the bid result, payment for the order is initiated and the project ends for all the other vendors. Once payment is initiated, the vendor can see the name of the renter as well as their production name and phone number. In one embodiment, payment to the vendor can be made via the equipment acquisition system or alternatively, can be made directly from the user to the vendor.

Although, the equipment acquisition system was described above with respect to industrial equipment, the acquisition system can be used for other types of goods, such as construction equipment, medical or dental equipment, and machinery. Other types of goods that are expensive to own and are specialized are possible.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for cloud-based industrial equipment acquisition, comprising:
a query comprising a list of industrial equipment;
a server comprising a central processing unit, memory, an input port to receive the query, and an output port, wherein the central processing unit is configured to:
perform fraud analysis on the query to determine whether the query is valid;
when valid, receive at least two results for the query from vendors of the industrial equipment, wherein each result includes one or more pieces of industrial equipment;
review the results, comprising:
compare the industrial equipment listed in each of the results with the list of industrial equipment provided in the query; and
identify any pieces of the industrial equipment that are missing from each of the results;
notify at least one of the vendors that at least one piece of industrial equipment is missing from one of the results;
receive a revision of the result; and
deliver the revised result and the remaining results to the user in response to the query, wherein the user obtains at least a portion of the industrial equipment from the vendor of at least one result.

2. A system according to claim 1, wherein the fraud analysis comprises:
assigning points to one or more elements of the query;
assigning points to a user of the query;
totaling the points for the query elements and the user;
applying a threshold to the totaled points; and
identifying the query as invalid when the totaled points exceed the threshold.

3. A system according to claim 2, wherein the central processing unit performs at least one of discarding the query, ignoring the query, and returning the query to the user when the query is invalid.

4. A system according to claim 1, wherein the central processing unit displays the results to the vendors that submitted the results and removes an identity of each vendor from the displayed results.

5. A system according to claim 1, wherein the central processing unit determines a trustworthiness of the user, comprising:
assigning a predetermined number of points to the user;
subtracting points for trustworthy actions performed by the user; and
adding points for untrustworthy actions performed by the user,
wherein a lower number of points is representative of the user being trustworthy.

6. A system according to claim 1, wherein the central processing unit generates recommendations for one such vendor for generating the result comprising recommendations for at least one of rental cost and promotions.

7. A system according to claim 6, wherein the recommendations can be based on attributes of the user comprising one or more of the user's production history, portfolio, budget, social following, and fraud detection scoring.

8. A system according to claim 1, wherein the central processing unit maintains inventory lists for one or more of the vendors and verifies that the industrial equipment in the result for that vendor is available.

9. A system according to claim 1, wherein the central processing unit identifies another vendor that has the missing equipment available and sends a notification of the other vendor to the vendor with the result having missing equipment.

10. A system according to claim 1, wherein the revised result comprises a portion of the industrial equipment from the vendor and a remaining portion of the industrial equipment from a different vendor.

11. A computer-implemented method for cloud-based industrial equipment acquisition, comprising:
receiving a query comprising a list of industrial equipment;
performing fraud analysis on the query to determine whether the query is valid;
when valid, receiving at least two results for the query from vendors of the industrial equipment, wherein each result includes one or more pieces of industrial equipment;
reviewing the results, comprising:
comparing the industrial equipment listed in each the results with the list of industrial equipment provided in the query; and
identifying any pieces of the industrial equipment that are missing from each of the results;
notifying at least one of the vendors that at least one piece of industrial equipment is missing from one of the results;
receiving a revision of the result; and
delivering the revised result and the other results to the user in response to the query, wherein the user obtains at least a portion of the industrial equipment from the vendor of at least one result.

12. A method according to claim 11, wherein the fraud analysis comprises:
assigning points to one or more elements of the query;
assigning points to a user of the query;
totaling the points for the query elements and the user;
applying a threshold to the totaled points; and
identifying the query as invalid when the totaled points exceed the threshold.

13. A method according to claim 12, further comprising:
when the query is invalid, performing at least one of discarding the query, ignoring the query, and returning the query to the user.

14. A method according to claim 11, further comprising:
displaying the results to the vendors that submitted the results, wherein an identity of each vendor is removed from the displayed results.

15. A method according to claim 11, further comprising:
determining a trustworthiness of the user, comprising:
assigning a predetermined number of points to the user;
subtracting points for trustworthy actions performed by the user; and
adding points for untrustworthy actions performed by the user,
wherein a lower number of points is representative of the user being trustworthy.

16. A method according to claim 11, further comprising:
generating recommendations for sending to one such vendor for generating the results comprising recommendations for at least one of rental cost and promotions.

17. A method according to claim 16, wherein the recommendations can be based on attributes of the user comprising one or more of the user's production history, portfolio, budget, social following, and fraud detection scoring.

18. A method according to claim 11, further comprising:
maintaining inventory lists for one or more of the vendors; and
verifying that the industrial equipment in the result for that vendor is available.

19. A method according to claim 11, further comprising:
identifying another vendor that has the missing equipment available; and
sending a notification of the other vendor to the vendor with the result having missing equipment.

20. A method according to claim 11, wherein the revised result comprises a portion of the industrial equipment from the vendor and a remaining portion of the industrial equipment from a different vendor.
